(19) United States
(12) Patent Application Publication
(10) Pub. No.: US 2017/0024787 A1
(43) Pub. Date: Jan. 26, 2017

(54) OMNICHANNEL SERVICES PLATFORM

(71) Applicant: Microsoft Technology Licensing, LLC, Redmond, WA (US)

(72) Inventors: Ashvin Mathew, Kirkland, WA (US); Yabin Liu, Kirkland, WA (US); Balaji Balasubramanian, Redmond, WA (US); Nic Surpatanu, Duvall, WA (US); Navid Azimi-Garakani, Redmond, WA (US)

(21) Appl. No.: 14/808,605

(22) Filed: Jul. 24, 2015

(51) Int. Cl. G06Q 30/06

(52) U.S. Cl. CPC G06Q 30/0605

(57) ABSTRACT

An omnichannel services platform includes a service orchestrator and a plurality of service modules. Each service module has a conforming service interface. A service manifest is operably coupled to the service orchestrator to allow the service orchestrator to call each of the plurality of services. The service manifest includes, at least, location information for each of the plurality of service modules.

### BACKGROUND

A vast majority of transactions in the transfer of goods or services are tracked and/or supported by computerized systems. For sellers, such electronic transaction support facilitates resource planning, reporting and ultimately efficient operation. Buyers are also empowered with significant abilities by virtue of electronic transaction support to research products and services and identify advantageous potential transactions.

Buyers typically view a seller as a single entity even though the seller may have hundreds of physical stores, an online storefront, and a significant social media presence. Buyers increasingly wish to deal with such a vast enterprise in a coherent experience. As such, sellers are beginning to provide a consolidated approach to the various channels by which a buyer could obtain goods or services. Such a consolidation of a seller's various channels (physical, virtual, et cetera) is termed an omnichannel.

The discussion above is merely provided for general background information and is not intended to be used as an aid in determining the scope of the claimed subject matter.

### SUMMARY

An omnichannel services platform includes a service orchestrator and a plurality of service modules. Each service module has a conforming service interface. A service manifest is operably coupled to the service orchestrator to allow the service orchestrator to call each of the plurality of services. The service manifest includes, at least, location information for each of the plurality of service modules.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a computing system providing omnichannel commerce services in accordance with one embodiment.

FIG. 2 is a diagrammatic view of a commerce services module of a computing system in accordance with one embodiment.

FIG. 3 is a diagrammatic view of a service orchestrator interacting with a number of services in accordance with one embodiment.

FIG. 4 is a block diagram of a service orchestrator with a manifest in accordance with one embodiment.

FIG. 5 is a block diagram of an illustrative service in accordance with one embodiment.

FIG. 6 is a block diagram of a variety of services and service orchestrators that are packaged by a commerce runtime in order to deliver an immersive, seamless omnichannel experience in accordance with one embodiment.

FIG. 7 is a flow diagram of a computer-implemented method of adding a service to an omnichannel services platform in accordance with one embodiment.

FIG. 8 is a block diagram of the architecture shown in FIG. 1, except that its elements are disposed in a cloud computing architecture.

FIG. 9 is a simplified block diagram of one illustrative embodiment of a handheld or mobile computing device that can be used as a user's or client's hand held device 16, in which the present system (or parts of it) can be deployed.

FIGS. 10-11 are examples of handheld or mobile devices which can be used in accordance with various embodiments described herein.

FIG. 12 is one embodiment of a computing environment in which embodiments described herein can be practiced.

### DETAILED DESCRIPTION

Embodiments described herein generally provide an omnichannel service platform that offers sellers the ability to provide a seamless experience for buyers through all channels including brick-and-mortar (B&M) stores, e-commerce online store, catalog mail order interactions, call center telephone orders, mobile shopping and so on, in the cloud, on premises, or any combination thereof. Omnichannel systems provided in the past have generally required complex integrations to connect all the subsystems in order to offer a seemingly seamless omnichannel consumer experience. Further, such attempts have generally increased cost of ownership due to customizations of cross-channel capabilities that required modification to many subsystems in order to accommodate different build technologies for different business goals and/or technologies available at different periods of time. Further still, such previous attempts have generally had limited deployment choices requiring a user to either select a purely on-premises solution, or a purely cloud-based solution.

Embodiments described below generally provide improvements over previous omnichannel service solutions. In particular, embodiments described herein generally deploy a distributed system architecture that offers choice with respect to deployment allowing the utilization of on-premises solutions, cloud-based solutions, as well as hybrid solutions that employ both on-premises aspects and cloud-based aspects. Further, embodiments described herein can seamlessly connect with components deployed in a public cloud, such as Azure, available from Microsoft Corporation of Redmond, Wash. Moreover, embodiments can also connect with a private cloud, and/or an on-premises solution (seller's environment), as desired. Various services of the platform can be selected by a seller in order to provide certain levels of native support. Further, embodiments described herein generally provide native support for connecting services in any location in accordance with a defined service contract that specifies interactions between various services and the service platform. Embodiments herein may also provide automatic data synchronization among all distributed subsystems as well as the ability to provide linear scale-out to increase system performance. Linear scale out means that performance of at least some embodiments can be increased linearly by simply adding additional hardware resources.

As will be appreciated, embodiments herein provide significant extensibility as well as relatively simple requirements for installation of new service modules for additional features. The extensibility applies not only to business data and operations, but to custom authentication providers as well.

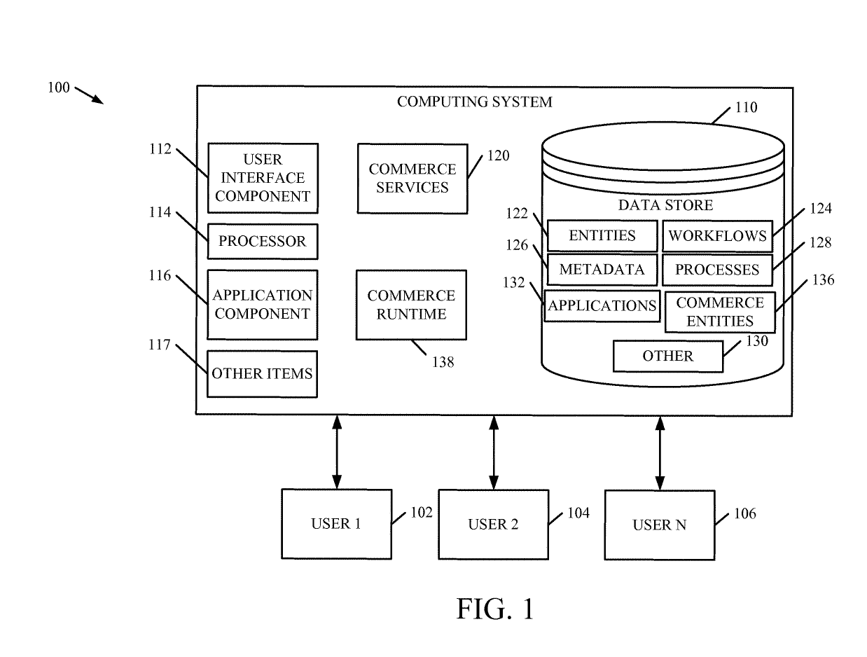

FIG. 1 is a diagrammatic view of a computing system with which embodiments of the present invention are particularly applicable. FIG. 1 illustrates computing system 100 that is accessible by one or more users through one or more user interfaces. For example, each of users 102 and 104 can access computing system 100 locally, or remotely. In one example, one or more of users 102 and 104 use a respective client device that communicates with computing system 100 over a wide area network, such as the internet. Embodiments described herein can make use of portable class libraries or other suitable technologies to provide cross-platform use for the various client devices. Thus, for example, the client device of user 102 may employ the Android operating system, while the client device of user 104 may employ the iOS operating system.

Users 102 and 104 interact with user input mechanisms to control and manipulate computing system 100. For instance, users 102 and 104 can access data in data store 110. User data access can include, but is not limited to, read access, write access, and/or update access to the data. Updating data can include modifying and/or deleting data in data store 110. For sake of illustration, users 102 and 104 are shown accessing system 100 in FIG. 1. However, it is understood that any number N of users can access system 100 as indicated at block 106.

In the example shown in FIG. 1, computing system 100 includes a user interface component 112, at least one processor 114, and an application component 116. System 100 can include other items 117 as well.

Processor 114 is illustratively a computer processor with associated memory and timing circuitry (not shown). Processor 114 is illustratively a functional part of system 100 and is activated by, and facilitates the functionality of, other systems and components and items in system 100.

Data store 110, in one embodiment, includes data entities 122, workflows 124, processes 128, and applications 132 that are implemented by application component 116 for users of computing system 100 to perform processes and tasks. Information in data store 110 further includes metadata 126, commerce entities 136, and any other data 130 that can be used by application component 116 or other items in computing system 100. Commerce entities 136 include business data and operations that help define and support commerce runtime module 138. Examples of commerce entities 136 include customer entities, product entities, and shopping cart entities. Entities 122, in one embodiment, describe entities within or otherwise used by system 100.

Computing system 100 can be any type of computing system. However, in one embodiment, computing system 100 comprises a business system, such as an enterprise resource planning (ERP) system. As such, applications 132 can be any suitable applications that may be executed by system 100 in order to perform one or more functions for which system 100 is deployed.

Application component 116 accesses the information in data store 110 in implementing the programs, workflows or other operations performed by application component 116. For instance, application component 116, in one example, runs applications 132, which can include workflows 124 and processes 128. Workflows 124, and processes 128, in one example, operate upon data entities 122 as well as other data 130 in order to enable the user to perform his or her operations within system 100. In one example, user interface component 112, either by itself or under the control of other items in system 100, generates user interface displays for the users.

User interface component 112 senses physical activities, for example by generating user interface displays that are used to sense user interaction with computing system 100. User interface displays can include user input mechanism that sense user inputs in a wide variety of different ways, such as point and click devices (e.g. a computer mouse or trackball) a keyboard (either virtual or hardware), a keypad, or a touch sensitive display. Similarly, the user inputs can illustratively be provided by voice inputs or other natural user interface input mechanisms as well.

FIG. 1 shows a variety of different functional blocks. It will be noted that the blocks can be consolidated so that more functionality is performed by each block, or they can be divided so that the functionality is further distributed.

It should also be noted that the above description has shown one or more data stores, including data store 110. Data store 110 can be any of a wide variety of different types of data stores. Further, the data in data store 110 can be stored in multiple additional data stores as well. Also, the data stores can be local to the environments, agents, modules, and/or components that access them, or they can be remote therefrom and accessible by those environments, agents, modules, and/or components. Similarly, some can be local while others are remote.

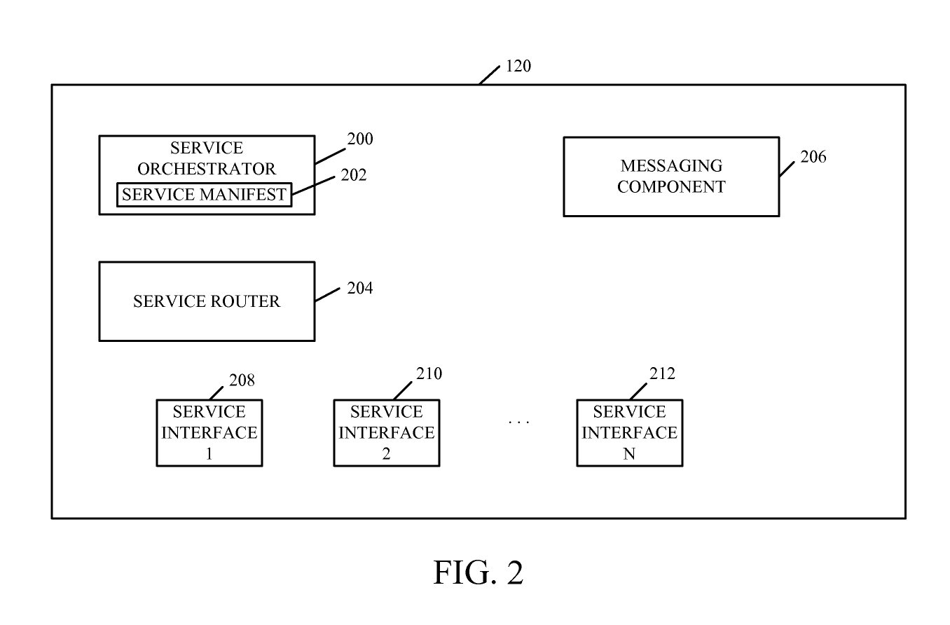

In accordance with one embodiment, computing system 100 includes commerce services module 120 and commerce runtime module 138. Commerce services module 120 facilitates a standardized, coherent approach to an omnichannel service platform, as will be described in further detail below with respect to FIG. 2. Additionally, commerce services module 120 can include plugins interfaces as well as out-of-the-box-implementations of these interfaces. Such plug-ins interfaces allow third party developers and service providers to create their own plugins to implement certain requirements. For example, a user may wish to implement a payment plugin to process a payment card using their own payment processor.

FIG. 2 is a diagrammatic view of commerce services component 120 in accordance with one embodiment. Commerce services component 120 includes a service orchestrator module 200 having service manifest 202. Service orchestrator 200 executes service manifest 202 in order to perform various operations for computing system 100. Service manifest 202 and metadata 126 support service orchestration and are pre-defined and extensible. Additionally, commerce services component 120 also includes service router 204 that generally supports metadata driven multi-layer service execution and rerouting. The utilization of service router 204 allows embodiments described herein to seamlessly interact with on-premises components and cloud-based components in order to provide effective hybrid-based implementations. Additionally, commerce services module 120 also includes messaging component 206 that defines communication between various commerce entities 136. Further, commerce services module 120 can interact with workflows 124 in order to generate various processes and operations. For example, a place order workflow of a shopping cart entity defines all necessary processes of placing a sale order, including reserving inventory, authorizing a card payment, sending a customer confirmation email et cetera.

Commerce services module 120 also includes a number of service interfaces 208, 210 and 212. Service interfaces 208, 210, and 212 are generally predefined and extensible service interfaces. These interfaces are considered a set of application interfaces that expose various operations and data in order to connect all system components. It is the standardization of this set of interfaces that allows system 100 to interact with various service modules in a way that allows a user of system 100 to pick and choose which services to provide. Further, if a seller wishes to provide additional services, an additional service component can simply be obtained and communicatively coupled to the service interfaces 208, 210, and 212.

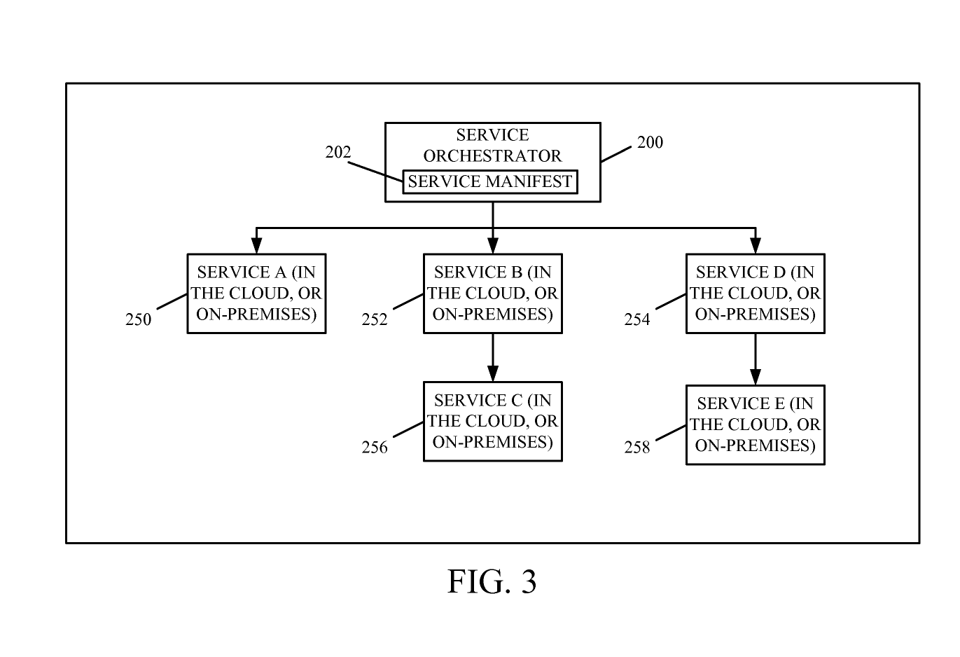

FIG. 3 is a diagrammatic view of a service orchestrator interacting with a variety of services in accordance with one embodiment. As shown in FIG. 3, service orchestrator 200 uses service manifest 202 in order to interact with services 250, 252, 254, 256, and 258. Service manifest 202 generally includes a listing of various services that are available, as well as the location (such as via Uniform Resource Locator) of such services. For example, service A may be a service for tax calculation and may be a cloud-based implementation. In such instance, service manifest 202 will indicate that service A is available to provide a service for tax calculation, and the location of service A in the cloud. Further, service B, 252, may be a service for price calculation and may be an on-premises service. In this case, service manifest 202 will indicate that service B, 252, provides a service for price calculation as well as a uniform resource locator indicating the on-premises location of service B. Further, as shown in FIG. 3, a given service may interact with another service. This is shown by service B, 252, interacting with service C, 256. Similarly, service D, 254 and E, 258 can be employed by service orchestrator 200 using service manifest 202.

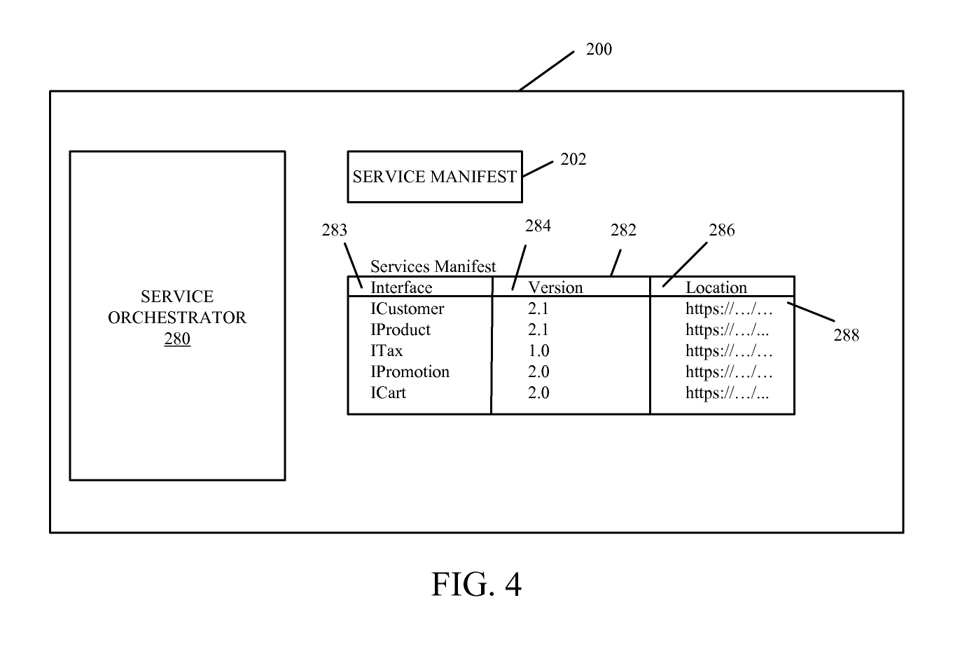

FIG. 4 is a diagrammatic view of service orchestrator 200 in accordance with one embodiment. Service orchestrator 200 includes service orchestrator module 280 that can be a collection of hardware, software, or a combination thereof, that utilizes processor 114 (shown in FIG. 1) to interact with various services to which system 100 is coupled. Additionally, service orchestrator 200 includes service manifest 202 which is a listing of various services provided. In the illustrated example, services manifest portion 282 includes an interface portion 283, a version portion 284, and a location portion 286. For the example service manifest shown in FIG. 4, a variety of individual services are shown. For example, an ICustomer interface is shown having version 2.1 and a respective location, as indicated at row 288. Similarly, other interfaces, 283, versions 284, and locations, 286 are illustrated in additional rows in manifest portion 282. Since various services can be listed in manifest 202 with any suitable location information 286, services can be located on premises, in a public cloud, in a private cloud or any other suitable location, as well as combinations thereof, as long the location of the service is properly reflected in service manifest 202. Moreover, adding new services is facilitated by simply updating or modifying service manifest 202.

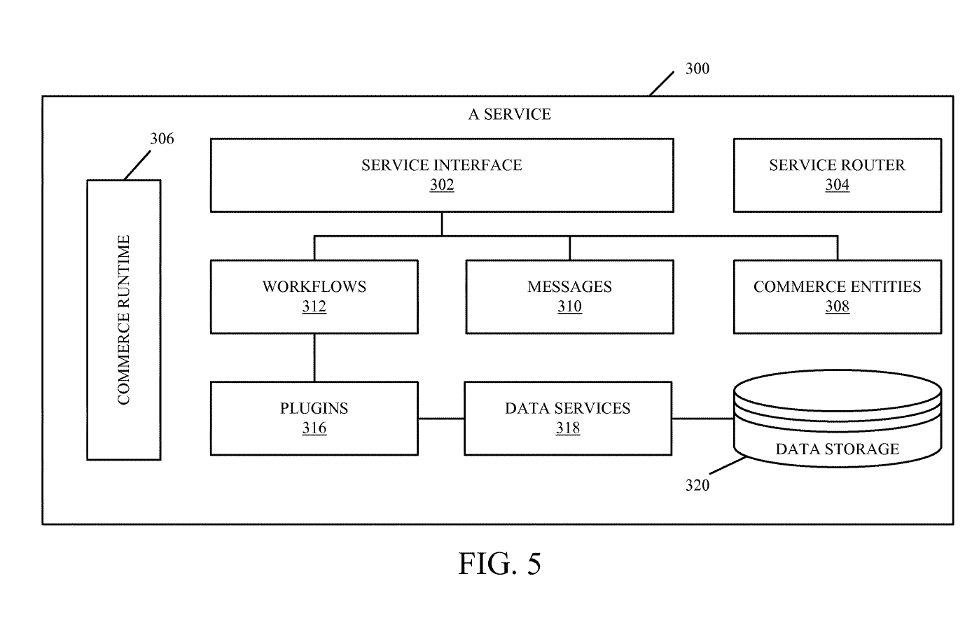

FIG. 5 is a diagrammatic view of a service module 300 usable with computing system 100 in accordance with one embodiment. Service module 300 includes service interface 302 that conforms to one or more service interfaces 208, 210, 212 of service module 120 (shown in FIG. 2). As such, the specification of service interface 302 allows the functionality of service module 300 to be added to system 100 without requiring significant changes to system 100 for operation. Service module 300 also include service router 304 that supports metadata driven multi-layer service execution and rerouting. Accordingly, service router 304 is much like service router 204 of services module 120. Service router 304 allows service module 300 to further interact with other services, such as shown in FIG. 3 with the interaction between services 252 and 256. Service module 300 also includes commerce runtime component 306 that is configured to interact with runtime component 138 of computing system 100 for execution during runtime. Service interface 302 generally interacts with commerce entities 308, messages 310, and workflows 312 via communication channel 314. Commerce entities 308 and workflows 312 generally conform to commerce entities 136 and workflows 124 of computing system 100. Additionally, workflows 312 may further interact with plugins module 316. Plugins module 316 may employ data services 318 and, accordingly data storage module 320. Service module 300 can provide any suitable function that is desirable to an operator of system 100. Examples include, without limitation, a service for tax calculation, a service for price calculation, a service for shopping cart management, et cetera.

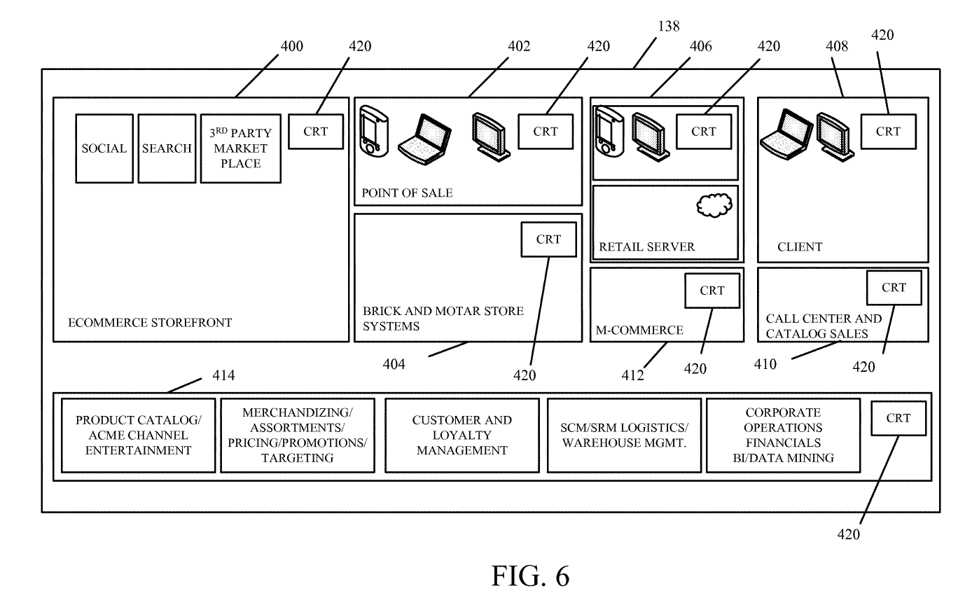

FIG. 6 is a diagrammatic view of commerce runtime module 138 in accordance with one embodiment. Commerce runtime 138 generally packages all services and service orchestrators in order to deliver an immersive, seamless omnichannel experience. As shown in FIG. 6, commerce runtime module 138 may include an e-commerce storefront module 400 that supports e-commerce storefront activities and transactions. In the example shown in FIG. 6, a point of sale module 402 is provided that supports point-of-sale transactions. As shown, module 402 also includes an interface portion 420. Additional modules also include a brick-and-mortar store system module 404, a retail server module 406, a business systems client module 408, a call center and catalog module 410, mobile-commerce module 412, and headquarters module 414. The headquarters module 414 may include any suitable number of submodules that support various headquarters functions. Examples, of such submodules include, without limitation, product catalog, merchandizing assortments, pricing, promotions, targeting, loyalty management, supply chain management (SCM) and/or supplier relationship management (SRM) logistics, warehouse management, corporate operations, financial operations, data mining, as well as any other suitable functions. Each of these various modules 400, 402, 404, 406, 408, 410, 412, and 414 generally include a commerce runtime module 420 that interacts with the various services associated with that module, during runtime. Accordingly, runtime component 138 generally provides infrastructure for all commerce runtime components. Thus, a symmetric schema is provided across all channels.

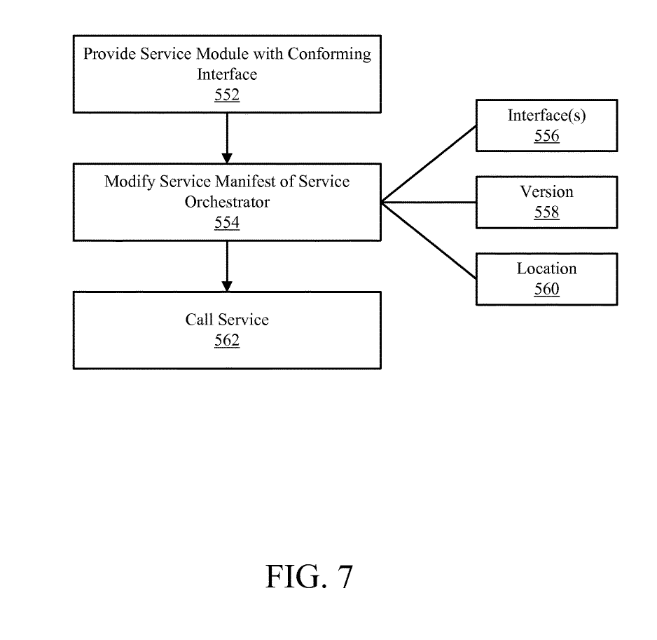

FIG. 7 is a flow diagram of a computer-implemented method of adding a service to an omnichannel services platform in accordance with one embodiment. Method 550 begins at block 552 where a service module having an interface that conforms to one or more service interfaces of the omnichannel services platform is provided. The service module can be service 300 described with respect to FIG. 5, or any other suitable service. Next, at block 554, a service manifest of the omnichannel services platform is modified to include information related to the new service module. Such information can include data pertaining to one or more interfaces 556 or functions provided by the new service; data pertaining to versions 558 or each such interface 556 or function; and data pertaining to a location 560 relative to each such interface 556 or function. The location information can be specific in the formal of a uniform resource locator or any other suitable manner. Next, at block 562, the service orchestrator of the services platform calls the new service using the modified service manifest.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Various user interface displays can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

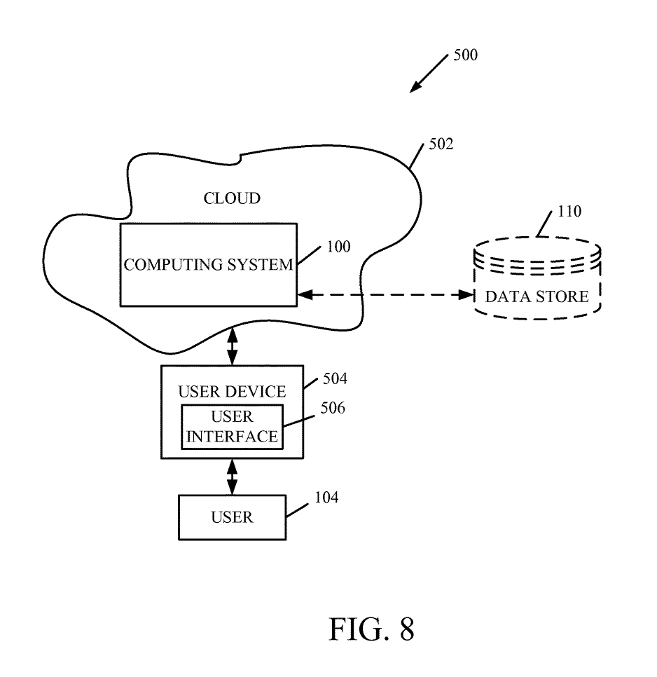

FIG. 8 is a block diagram of an architecture 500 including computing system 100 shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of computing system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, et cetera.

In the embodiment shown in FIG. 8, some items are similar to those shown in FIG. 1 and they are similarly numbered. FIG. 8 specifically shows that computing system 100 is located in cloud 502 (which can be public, private, or a combination where portions are public while others are private). Therefore, a user such as user 104 uses a device 504 having user interface 506 to access those systems through cloud 502.

FIG. 8 also depicts another embodiment of a cloud architecture. FIG. 8 shows that it is also contemplated that some elements of computing system 100 are disposed in cloud 502 while others are not. By way of example, data stores 110 can be disposed outside of cloud 502, and accessed through cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that computing system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, et cetera.

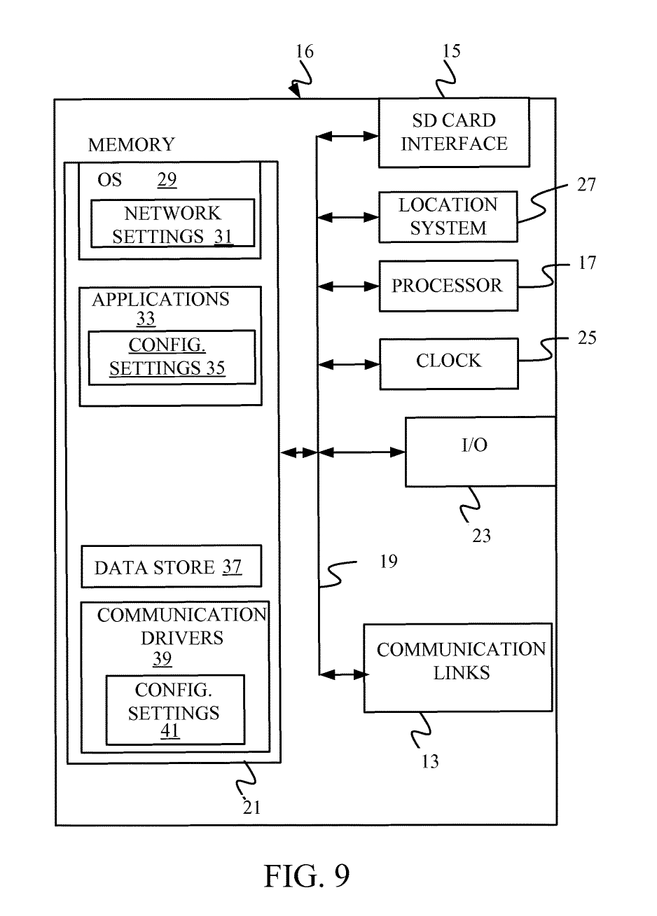

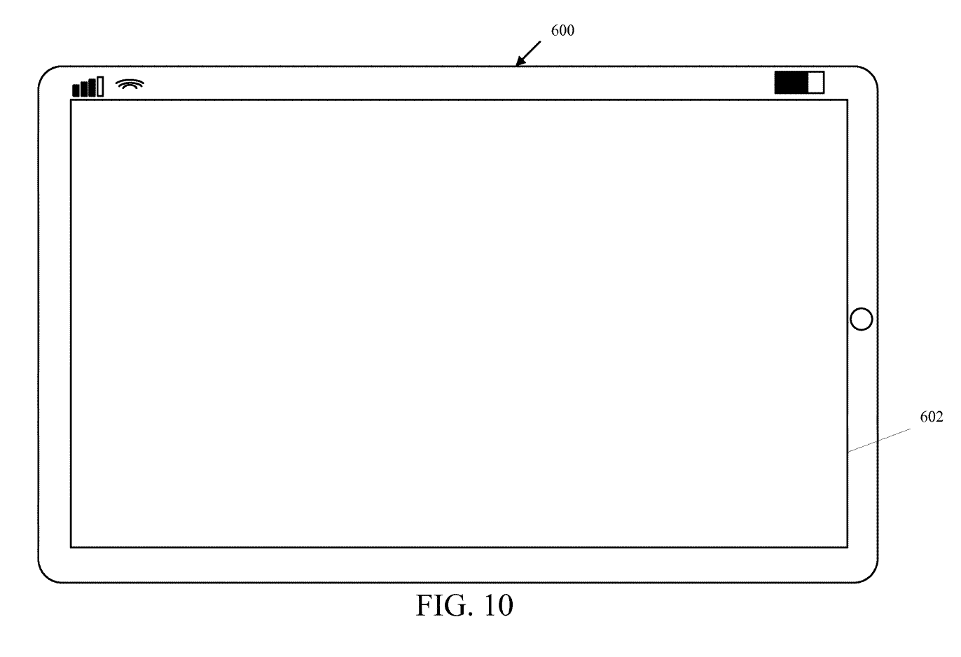

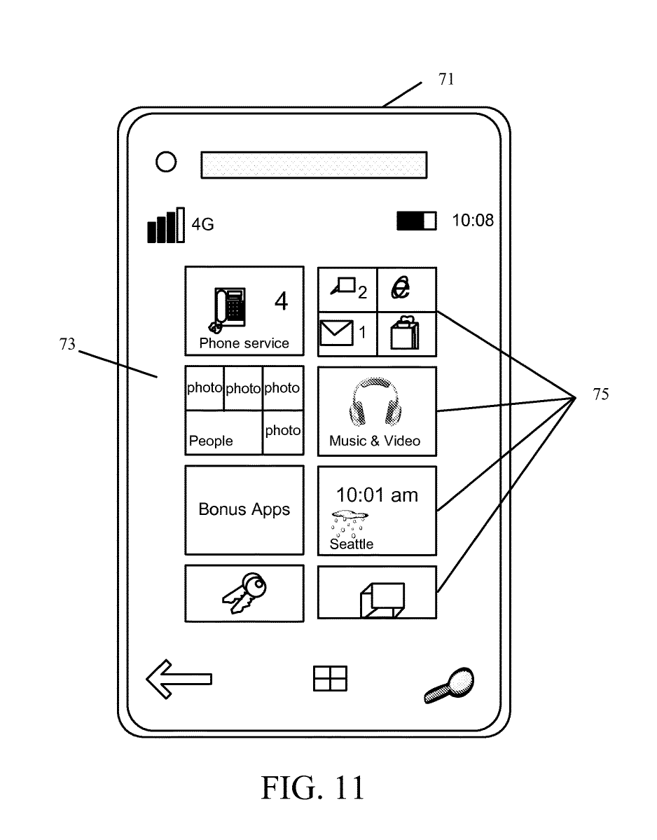

FIG. 9 is a simplified block diagram of one illustrative embodiment of a handheld or mobile computing device that can be used as a user's or client's hand held device 16, in which the present system (or parts of it) can be deployed. FIGS. 10 and 11 are examples of handheld or mobile devices.

FIG. 9 provides a general block diagram of the components of a client device 16 that can run components of computing system 100 or that interacts with system 100, or both. In the device 16, a communications link 13 is provided that allows the handheld device to communicate with other computing devices and under some embodiments provides a channel for receiving information automatically. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Device 16 can have a client business system 24 which can run various business applications or embody parts or all of computing system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 10 one embodiment in which device 16 is a tablet computer 600. In FIG. 10, computer 600 is shown with display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 11 provides an additional example of devices 16 that can be used, although others can be used as well. In FIG. 11, the mobile device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. Note that other forms of the devices 16 are possible.

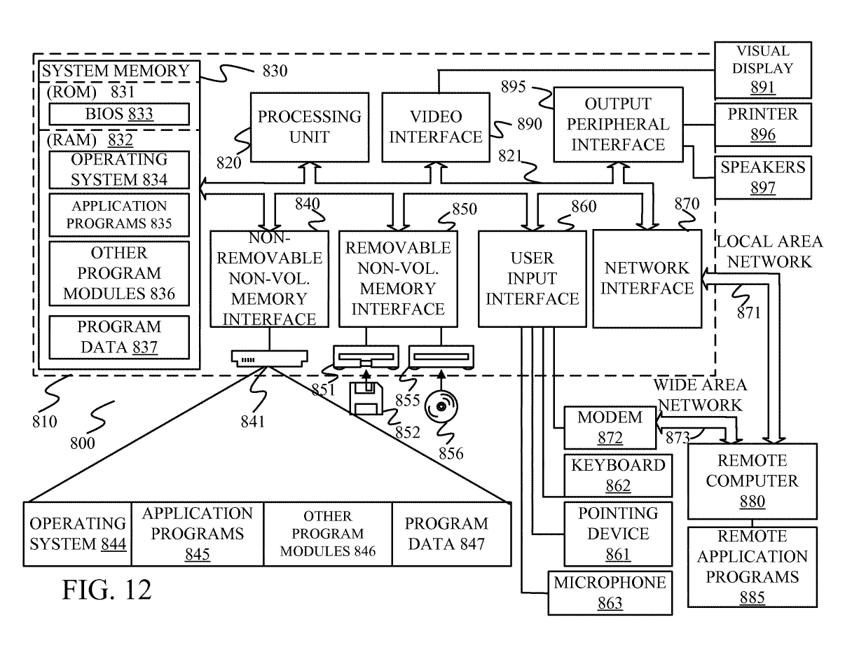

FIG. 12 is one example of a computing environment in which computing system 100, or parts of it, (for example) can be deployed. With reference to FIG. 12, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is an omnichannel services platform that includes a service orchestrator and a plurality of service modules. Each service module has a conforming service interface. A service manifest is operably coupled to the service orchestrator to allow the service orchestrator to call each of the plurality of services. The service manifest includes, at least, location information for each of the plurality of service modules.

Example 2 is the omnichannel services platform of any or all previous examples wherein at least one of the plurality of services is an on-premises service.

Example 3 is the omnichannel services platform of any or all previous examples wherein at least one of the plurality of services is a cloud-based service.

Example 4 is the omnichannel services platform of any or all previous examples wherein the location information for each of the service modules is set forth in a uniform resource locator.

Example 5 is the omnichannel services platform of any or all previous examples wherein the service manifest includes interface information relative to each service module.

Example 6 is the omnichannel services platform of any or all previous examples wherein the service manifest includes version information relative to each service module.

Example 7 is the omnichannel services platform of any or all previous examples and further comprising a messaging component configured to provide communication between commerce entities.

Example 8 is the omnichannel services platform of any or all previous examples and further comprising a plurality of interfaces, at least one of which is configured to interact with the conforming interface of each service module.

Example 9 is the omnichannel services platform of any or all previous examples and further comprising a service router configured to support metadata driven multi-layer service execution.

Example 10 is the omnichannel services platform of any or all previous examples wherein the service manifest is a component of the service orchestrator.

Example 11 is a computer-implemented method of adding a service module to an omnichannel services platform. The method includes providing a service module having an interface that conforms to at least one service interface of the omnichannel service platform. A service manifest of the omnichannel services platform is modified with information relative to the service module. The service module is called using the modified service manifest.

Example 12 is the computer-implemented method of any or all previous examples wherein calling the service module is performed using a service orchestrator that accesses the modified service manifest.

Example 13 is the computer-implemented method of any or all previous examples wherein the information relative to the service module includes location information.

Example 14 is the computer-implemented method of any or all previous examples wherein the location information specifies a location that is remote from the omnichannel services platform.

Example 15 is the computer-implemented method of any or all previous examples wherein the location information specifies a location at the same premises as the omnichannel services platform.

Example 16 is the computer-implemented method of any or all previous examples wherein the information relative to the service module includes interface information.

Example 17 is the computer-implemented method of any or all previous examples wherein the information relative to the service module includes version information.

Example 18 is a service module for an omnichannel services platform. The service module includes a service interface conforming to at least one interface of the omnichannel services platform. A data store has at least one entity that conforms to the omnichannel services platform. A messaging component is configured to provide communication between entities.

Example 19 is the service module for an omnichannel services platform of any or all previous examples and further comprising a service router configured to communicate with at least one additional service module.

Example 20 is the service module for an omnichannel services platform of any or all previous examples wherein the at least one entity is a commerce entity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An omnichannel services platform comprising:
a service orchestrator;
a plurality of service modules, each having a conforming service interface; and
a service manifest operably coupled to the service orchestrator to allow the service orchestrator to call each of the plurality of services, the service manifest including, at least, location information for each of the plurality of service modules.

2. The omnichannel services platform of claim 1, wherein at least one of the plurality of services is an on-premises service.

3. The omnichannel services platform of claim 2, wherein at least one of the plurality of services is a cloud-based service.

4. The omnichannel services platform of claim 3, wherein the location information for each of the service modules is set forth in a uniform resource locator.

5. The omnichannel services platform of claim 1, wherein the service manifest includes interface information relative to each service module.

6. The omnichannel services platform of claim 1, wherein the service manifest includes version information relative to each service module.

7. The omnichannel services platform of claim 1, and further comprising a messaging component configured to provide communication between commerce entities.

8. The omnichannel services platform of claim 1, and further comprising a plurality of interfaces, at least one of which is configured to interact with the conforming interface of each service module.

9. The omnichannel services platform of claim 1, and further comprising a service router configured to support metadata driven multi-layer service execution.

10. The omnichannel service platform of claim 1, wherein the service manifest is a component of the service orchestrator.

11. A computer-implemented method of adding a service module to an omnichannel services platform, the method comprising:
providing a service module having an interface that conforms to at least one service interface of the omnichannel service platform;
modifying a service manifest of the omnichannel services platform with information relative to the service module; and
calling the service module using the modified service manifest.

12. The computer-implemented method of claim 11, wherein calling the service module is performed using a service orchestrator that accesses the modified service manifest.

13. The computer-implemented method of claim 11, wherein the information relative to the service module includes location information.

14. The computer-implemented method of claim 13, wherein the location information specifies a location that is remote from the omnichannel services platform.

15. The computer-implemented method of claim 13, wherein the location information specifies a location at the same premises as the omnichannel services platform.

16. The computer-implemented method of claim 11, wherein the information relative to the service module includes interface information.

17. The computer-implemented method of claim 11, wherein the information relative to the service module includes version information.

18. A service module for an omnichannel services platform, the service module comprising:
a service interface conforming to at least one interface of the omnichannel services platform;
a data store having at least one entity that conforms to the omnichannel services platform; and
a messaging component configured to provide communication between entities.

19. The service module of claim 18, and further comprising a service router configured to communicate with at least one additional service module.

20. The service module of claim 18, wherein the at least one entity is a commerce entity.
